(19) United States
(12) Patent Application Publication
(10) Pub. No.: US 2021/0295277 A1
(43) Pub. Date: Sep. 23, 2021

(54) METHOD, SYSTEM, AND NON-TRANSITORY COMPUTER READABLE RECORD MEDIUM FOR PAYMENT LINK

(71) Applicant: LINE CORPORATION, Tokyo (JP)

(72) Inventors: Sungjae LEE, Seongnam-si (KR); Gil Do Kim, Seongnam-si (KR); Jaepil Ryu, Seongnam-si (KR); Hye Kyoung Ahn, Seongnam-si (KR); Youn Shin Kang, Seongnam-si (KR)

(73) Assignee: LINE CORPORATION, Tokyo (JP)

(21) Appl. No.: 17/181,526

(22) Filed: Feb. 22, 2021

(30) Foreign Application Priority Data
Mar. 20, 2020 (KR) 10-2020-0034583

(51) Int. Cl. G06Q 20/02; G06Q 20/32; G06Q 40/02; G06Q 20/40; G06Q 20/38

(52) U.S. Cl. CPC G06Q 20/02; G06Q 20/326; G06Q 20/381; G06Q 20/405; G06Q 20/4037; G06Q 40/02

(57) ABSTRACT

A method, a system, and a non-transitory computer-readable record medium for a payment link may be provided. A payment link method implemented by a computer system, may include: verifying whether a second payment application is a transaction link target in response to a transaction request, which is received from a first payment application installed on an electronic device, occurring at a payment processing system that uses the second payment application different from the first payment application; and forwarding payment information on the first payment application to a payment server associated with the second payment application and linking a transaction between the first payment application and the second payment application in response to the second payment application corresponding to the transaction link target.

### CROSS-REFERENCE TO RELATED APPLICATION

This application claims priority from Korean Patent Application No. 10-2020-0034583, filed Mar. 20, 2020 in the Korean Intellectual Property Office, the disclosure of which is incorporated herein by reference in its entirety.

### BACKGROUND

### 1. Field

Apparatuses and methods consistent with example embodiments relate to linking different payment services.

### 2. Description of Related Art

Currently, mobile devices, such as smartphones, are widely used, and provide features that allow users to make a payment for a product or a service through the mobile devices.

For example, a mobile terminal enables a payment based on an affiliated store quick read (QR) code with communication with an affiliated store.

### SUMMARY

One or more example embodiments provide an apparatus and a method for linking a transaction between heterogenous payment applications.

Further, one or more example embodiments provide an apparatus and a method for linking a transaction that occurs by using a first payment application with a second payment application used by a user.

According to an aspect of at least one example embodiment, there is provided a payment link method implemented by a computer system, the payment link method including: verifying whether a second payment application is a transaction link target in response to a transaction request, which is received from a first payment application installed on an electronic device, occurring at a payment processing system that uses the second payment application different from the first payment application; and forwarding payment information on the first payment application to a payment server associated with the second payment application and linking a transaction between the first payment application and the second payment application in response to the second payment application corresponding to the transaction link target.

The linking the transaction may include processing the payment information on the first payment application to information transactable on the second payment application and forwarding the processed payment information to the payment server.

The linking the transaction may include: verifying that an amount corresponding to the transaction request from a user account of the first payment application is deposited; and settling the deposited amount to be transferred to the payment server based on a preset condition.

The linking the transaction may include creating a virtual user of the second payment application for an authorized user of the first payment application.

The verifying may include retrieving the second payment application from a list of payment applications pre-registered as targets to support a heterogenous payment link between different payment applications.

The payment server associated with the second payment application may be a second payment server, and the linking the transaction may include processing a payment for product transaction information created by the second payment application through interaction with a first payment server associated with the first payment application and the second payment server in response to receiving a payment request from the first payment application for the product transaction information.

The payment server associated with the second payment application may be a second payment server, and the linking the transaction may include processing a remittance for an amount corresponding to a remittance request through interaction with a first payment server associated with the first payment application and the second payment server in response to receiving, from the first payment application, the remittance request for the payment processing system that uses the second payment application.

The payment link method may further include: selecting a payment application to be used for a first transaction with the first payment application based on priority set by the computer system or the payment processing system in response to a plurality of payment applications comprising the second payment application being used at the payment processing system.

The payment link method may further include: selecting a payment application to be used for a second transaction with the second payment application based on priority set by the computer system or the payment processing system, in response to a plurality of payment applications comprising the first payment application being used by the electronic device.

The linking the transaction may include linking the transaction between the first payment application and the second payment application based on exchange rate information between a first currency used in the first payment application and a second currency used in the second payment application in response to the first currency being different from the second currency.

According to an aspect of at least one example embodiment, there is provided a non-transitory computer-readable record medium storing instructions that, when executed by a processor, cause the processor to perform the payment link method.

According to an aspect of at least one example embodiment, there is provided a computer system including: at least one memory configured to store computer-readable instructions; and at least one processor configured to execute the computer-readable instructions to: verify whether a second payment application is a transaction link target in response to a transaction request, which is received from a first payment application installed on an electronic device, occurring at a payment processing system that uses the second payment application different from the first payment application; and forward payment information on the first payment application to a payment server associated with the second payment application and link a transaction between the first payment application and the second payment application in response to the second payment application corresponding to the transaction link target.

The at least one processor may be further configured to execute the computer-readable instructions to: process the payment information on the first payment application to information transactable on the second payment application; and forward the processed payment information to the payment server to link the transaction between the first payment application and the second payment application.

The at least one processor may be further configured to execute the computer-readable instructions to: verify that an amount corresponding to the transaction request from a user account of the first payment application is deposited; and settle the deposited amount to be transferred to the payment server based on a preset condition.

The at least one processor may be further configured to execute the computer-readable instructions to: create a virtual user of the second payment application for an authorized user of the first payment application.

The at least one processor may be further configured to execute the computer-readable instructions to: retrieve the second payment application from a list of payment applications pre-registered as targets to support a heterogenous payment link between different payment applications.

The payment server associated with the second payment application may be a second payment server, and wherein the at least one processor may be further configured to execute the computer-readable instructions to: process a payment for product transaction information created by the second payment application through interaction with a first payment server associated with the first payment application and the second payment server in response to receiving a payment request from the first payment application for the product transaction information.

The payment server associated with the second payment application may be a second payment server, and the at least one processor may be further configured to execute the computer-readable instructions to: process a remittance for an amount corresponding to a remittance request through interaction with a first payment server associated with the first payment application and the second payment server in response to receiving, from the first payment application, the remittance request for the payment processing system that uses the second payment application.

The at least one processor may be further configured to execute the computer-readable instructions to: select a payment application to be used for a first transaction with the first payment application based on priority set by the computer system or the payment processing system, in response to a plurality of payment applications comprising the second payment application being used at the payment processing system.

The at least one processor may be further configured to execute the computer-readable instructions to: link the transaction between the first payment application and the second payment application based on exchange rate information between a first currency used in the first payment application and a second currency used in the second payment application in response to the first currency being different from the second currency.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of an electronic device and a server according to at least one example embodiment;

FIG. 3 illustrates an example of an architecture of a general simple payment system;

FIG. 4 illustrates an example of an architecture of a payment link system according to at least one example embodiment;

FIG. 5 is a diagram illustrating an example of components includable in a processor of a server according to at least one example embodiment;

FIG. 6 is a flowchart illustrating an example of a method performed by a server according to at least one example embodiment;

FIGS. 7 and 8 illustrate examples of a payment sequence diagram according to at least one example embodiment;

FIGS. 9 and 10 illustrate examples of a remittance sequence diagram according to at least one example embodiment; and

FIG. 11 illustrates an example of a plug-in sequence diagram according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for linking different payment services.

The example embodiments including the disclosures described herein may link a transaction between different payment applications each providing a simple payment service.

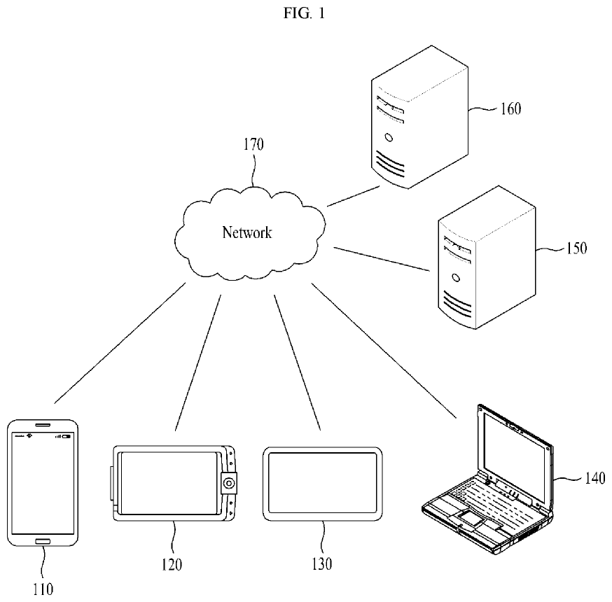

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, and the like, through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, for example, the server 150 may provide, as the first service, a service (e.g., a simple payment service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

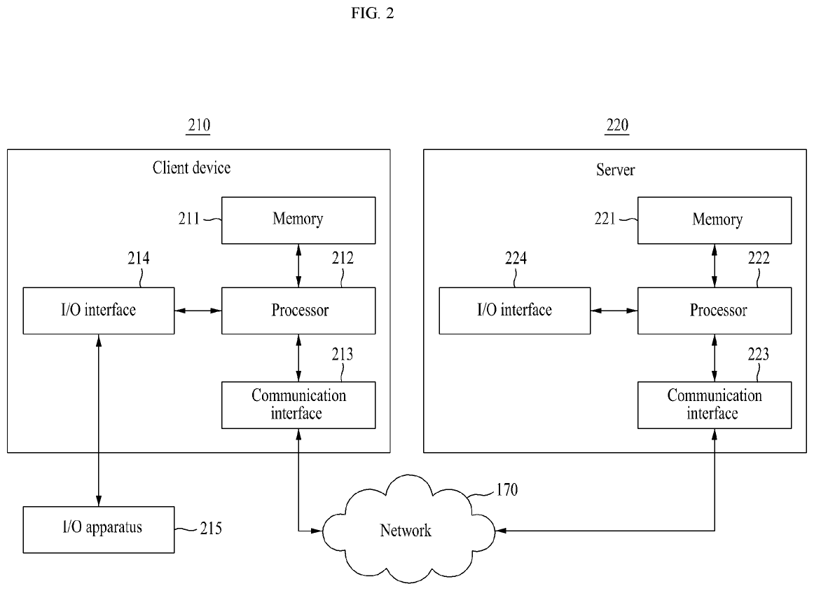

FIG. 2 is a block diagram illustrating an example of a client device 210 and a server 220 according to at least one example embodiment. The client device 210 may correspond to any of the electronic devices 110, 120, 130, and 140 shown in FIG. 1, and the server 220 may correspond to any of the servers 150 and 160 shown in FIG. 1.

Referring to FIG. 2, the client device 210 may include a memory 211, a processor 212, a communication interface 213, and an input/output (I/O) interface 214, and the server 220 may include a memory 221, a processor 222, a communication interface 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the client device 210 or the server 220 as a permanent storage device separate from the memory 211, 221. Also, an OS and at least one program code, for example, a code for a browser installed and executed on the client device 210 or an application installed and executed on the client device 210 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the client device 210 and another client device or another server, and between the server 220 and another client device or server. For example, the processor 212 of the client device 210 may forward a request created based on a program code stored in the storage device such as the memory 211, to the server 220 over the network 170 under control of the communication interface 213. The client device 210 may receive a control signal, an instruction, content, a file, and the like, provided under control of the processor 222 of the server 220 through the communication interface 213 of the client device 210, from the communication interface 223 of the server 220. For example, a control signal, an instruction, content, a file, and the like of the server 220 received through the communication interface 213 may be forwarded to the processor 212 or the memory 211, and content, a file, and the like, may be stored in a storage medium, for example, the permanent storage device, further includable in the client device 210.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the client device 210. Also, the I/O interface 224 of the server 220 may be a device for interface with an apparatus for input or output that may be connected to the server 220 or included in the server 220. In detail, when the processor 212 of the client device 210 processes an instruction of a computer program loaded to the memory 211, content or a service screen configured based on data provided from the server 220 or the client device 210 may be displayed on the display through the I/O interface 214.

According to other example embodiments, the client device 210 and the server 220 may include a number of components greater than or less than a number of components shown in FIG. 2. However, there is no need to clearly illustrate many components according to the related art. For example, the client device 210 may include at least a portion of the I/O apparatus 215, or may further include other components, for example, a transceiver, a global positioning system (GPS) module, a camera, a variety of sensors, a database (DB), and the like. In detail, if the client device 210 is a smartphone, the client device 210 may be configured to further include a variety of components, for example, an acceleration sensor, a gyro sensor, a camera module, various physical buttons, a button using a touch panel, an I/O port, a vibrator for vibration, etc., which are generally included in the smartphone.

The example embodiments relate to technology for providing a simple payment service (hereinafter, also briefly referred to as a pay) called a smart payment.

In the related art, to pay with a specific payment application, a recognizable terminal is required for each affiliated store through an affiliated store registration. Here, only a payment application registered to a corresponding affiliated store is available.

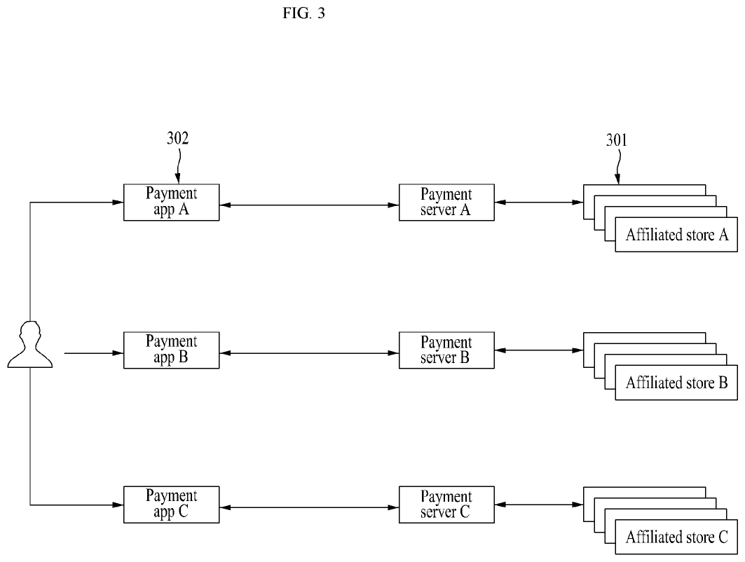

FIG. 3 illustrates an example of an architecture of a general simple payment system.

Referring to FIG. 3, only a separate payment application A 302 registered at an affiliated store A 301 may be used for a transaction with the affiliated store A 301. A payment with a payment application B or a payment application C may not be allowed in the affiliated store A 301 that does not support the payment application B and the payment application C.

A user may proceed with a payment for the affiliated store A 301 using the payment application A 302 supported at the affiliated store A 301. For example, a user who uses the payment application A 302 may be able to make a payment only at the affiliated store A 301 that supports the payment application A 302 and may not able to do so at another affiliated store B or C that does not support the payment application A.

To resolve such an issue in the existing simple payment system, example embodiments of the present disclosure may provide an apparatus and a method for processing a payment that occurs at a system (e.g., a retail store payment processing system or device) that does not support a payment application used by a user who makes the payment.

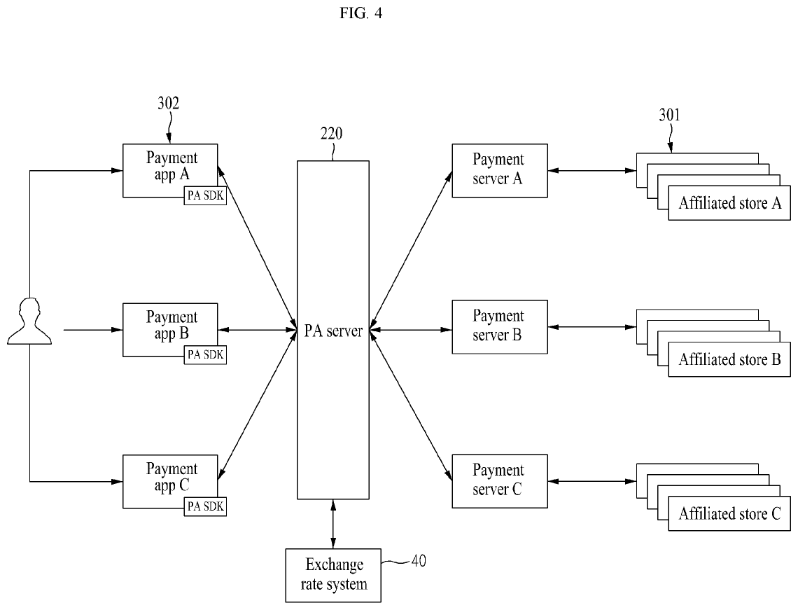

FIG. 4 illustrates an example of an architecture of a system for linking a transaction between heterogenous payment applications (hereinafter, a payment link system) according to at least one example embodiment.

Referring to FIG. 4, a payment association (PA) server may correspond to, for example, the server 220 shown in FIG. 2 (hereinafter, also referred to as the PA server 220) configured to link heterogenous payments and may process a payment for an affiliated store that supports a different payment application through the payment application 302 used by the user according to linking of the PA server 220.

The affiliated store 301 does not need to be registered as an affiliated store for a plurality of payments. Although at least one of a plurality of payments supported by the PA server 220 is registered at the affiliated store 301, the affiliated store 301 may process a transaction with a heterogenous payment application.

The user may visit the affiliated stores B and C that support the payment application B and C, which are different from the payment application A installed on the electronic device 110 of the user. A payment processing system at the affiliated store B or C may not directly support the payment application A.

The payment application 302 that implements a standardized software development kit (SDK) for the PA server 220 may use all of the affiliated stores A, B, and C that support a heterogenous payment, and any types of payments are supported by the PA server 220. Although it is described that communication with the PA server 220 is used for a link between heterogenous payments (hereinafter, also referred to as a payment link), it is provided as an example only. An application programming interface (API) call method may be applied.

Depending on example embodiments, a remittance for another user using the payment application B or C different from the payment application A 302 used by the user may be performed through a payment link of the PA server 220 in a similar manner. Also, when different currencies are used between users, currency exchange may be performed by applying a preset exchange rate through an exchange rate system 40 interactable with the PA server 220. The PA server 220 allows a payment link for overseas or international payment (or purchase) or remittance through interaction with the exchange rate system 40.

Hereinafter, example embodiments of a method and system for linking a transaction between heterogenous payment applications, that is, a method and system for a payment link are described.

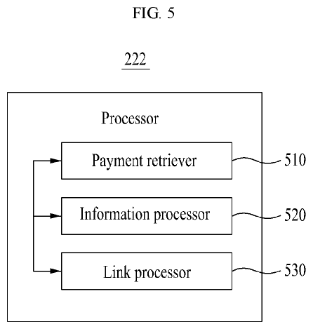

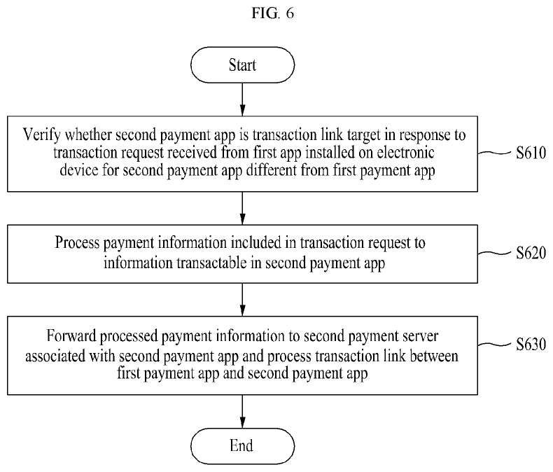

FIG. 5 is a diagram illustrating an example of components includable in a processor of a server according to at least one example embodiment, and FIG. 6 is a flowchart illustrating an example of a method performed by a server according to at least one example embodiment.

The PA server 220 according to the example embodiment serves as a link server configured to link heterogenous payments. A computer-implemented payment link system may be configured in the PA server 220. The PA server 220 may link different payment services with respect to the plurality of electronic devices 110, 120, 130, and 140 that are operated as client devices, and may link heterogenous payments through dedicated applications (hereinafter, also referred to as payment applications) installed on the electronic devices 110, 120, 130, and 140. The PA server 220 may provide a universal payment processing system by linking different types of dedicated payment applications (e.g., payment applications A, B, and C which are dedicated to the payment processing systems at the affiliated stores A, B, and C, respectively).

Referring to FIG. 5, to perform a method of linking a transaction between heterogenous payment applications (hereinafter, a payment link method) of FIG. 6, the processor 222 of the PA server 220 may include a payment retriever 510, an information processor 520, and a link processor 530. Depending on example embodiments, the components of the processor 222 may be selectively included in or excluded from the processor 222. Also, depending on example embodiments, the components of the processor 222 may be separated or merged for representations of functions of the processor 222.

The processor 222 and the components of the processor 222 may control the PA server 220 to perform operations 5610 to 5630 included in the payment link method of FIG. 6. For example, the processor 222 and the components of the processor 222 may be configured to execute an instruction according to a code of at least one program and a code of an OS included in the memory 221.

Here, the components of the processor 222 may be representations of different functions of the processor 222 performed by the processor 222 in response to an instruction provided from the program code stored in the PA server 220. For example, the payment retriever 510 may be used as a functional representation of the processor 222 that controls the PA server 220 to retrieve a linkable payment application in response to the instruction.

The processor 222 may read instructions from the memory 221 to control the PA server 220. In this case, the read instruction may include an instruction for controlling the processor 222 to perform the following operations S610 to S630. The following operations S610 to S630 may be performed in the order different from the order of FIG. 6 and a portion of operations S610 to S630 may be omitted or an additional process may be further included in operations S610 to S630.

Referring to FIG. 6, in operation S610, the payment retriever 510 may verify whether a second payment application is a transaction link target in response to a transaction request received from a first simple payment service application (hereinafter, a first payment application) that is installed on the electronic device 110 for the electronic device 120 on which a second simple payment service application (hereinafter, a second payment application) different from the first payment application is installed.

The term “transaction” used herein may include a payment, a remittance, and the like. The electronic device 110 may request a payment or a remittance for a terminal, for example, the electronic device 120, of another user using the second payment application that is a heterogenous payment application, through the first payment application used by the user of the electronic device 110.

The transaction request may include information required for a transaction between the first payment application and the second payment application. For example, the transaction request may include an identifier of the second payment application, an identifier of the electronic device 120 that is a transaction target, and payment information registered to the first payment application as payment information related to the user of the electronic device 110. For example, the payment information may include credit card information, debit card information, and account information as information about a payment method available for a payment or a remittance.

The PA server 220 may construct in advance a list of payment applications registered as targets that support a payment link and may maintain the list of payment applications. The list of payment applications may include an identifier of each payment application that allows a payment link. A payment application registered as a payment link target may be implemented using a standardized SDK or API and payment information of each user may be stored on a corresponding pay platform.

The first payment application may correspond to the payment link target. The payment retriever 510 may verify whether the second payment application requested by the user of the electronic device 110 for a transaction through the first payment application is included in the list of payment applications registered on the PA server 220, that is, whether the second payment application corresponds to a payment link target that allows a payment link.

When the second payment application is determined to correspond to the payment link target in operation S610, the information processor 520 may process the payment information included in the transaction request received from the electronic device 110 to information transactable on the second payment application in operation S620. When the second payment application for which the transaction the user of the electronic device 110 requests using the first payment application is verified to be registered to the PA server 220, the information processor 520 may process payment information related to the user of the electronic device 110 as information for a payment in a terminal, for example, the electronic device 120, of another user that uses the second payment application.

In operation S630, the link processor 530 may forward the payment information processed in operation S620 to a server (hereinafter, a second payment server) associated with the second payment application and may process a transaction link between the first payment application and the second payment application. A payment server associated with each payment application may refer to a computer system capable of communicating with the electronic devices 110, 120, 130, and 140 and/or the server 220 over the network 170.

The link processor 530 may forward, to the second payment server, information processed for the transaction with the second payment application different from the first payment application and may link the transaction between the first payment application and the second payment application. The PA server 220 may link the transaction between the first payment application and the second payment application through interaction with a server (hereinafter, a first payment server) associated with the first payment application and the second payment server. The transaction corresponding to the transaction request according to linking of the PA server 220 may be processed in such a manner that the first payment server uses payment information stored on the first payment application as payment information related to the user of the electronic device 110 and the second payment server uses payment information received from the PA server 220.

In relaying a transaction, for example, a payment and a remittance, the PA server 220 may immediately transfer a transaction request amount from a user account of the first payment application to the second payment server. As another example, the PA server 220 may temporarily deposit the transaction request amount from the user account of the first payment application and may settle the deposited transaction request amount to be transferred to the second payment server based on a preset condition, for example, a deposit period and a user transaction confirmation. Here, the PA server 220 may directly deposit the transaction request amount or may ensure depositing of the transaction request amount through interaction with a financial server associated with the second payment server. As another example, the PA server 220 may create a fake or virtual user of the second payment application for the (authorized or real) user of the first payment application that requests the corresponding transaction, and may regard the created fake or virtual user as the same as the authorized or real user of the first payment application and may link a transaction transfer between the first payment server and the second payment server.

The example embodiments may perform a transaction between heterogenous payment applications each providing a simple payment service according to linking of the PA server 220. The PA server 220 may process a transaction, for example, a payment and a remittance, between different pays and may also process logging, settlement, and authentication associated with the transaction. A payment application allows a transaction with another pay by communicating with the PA server 220 through an SDK or API call.

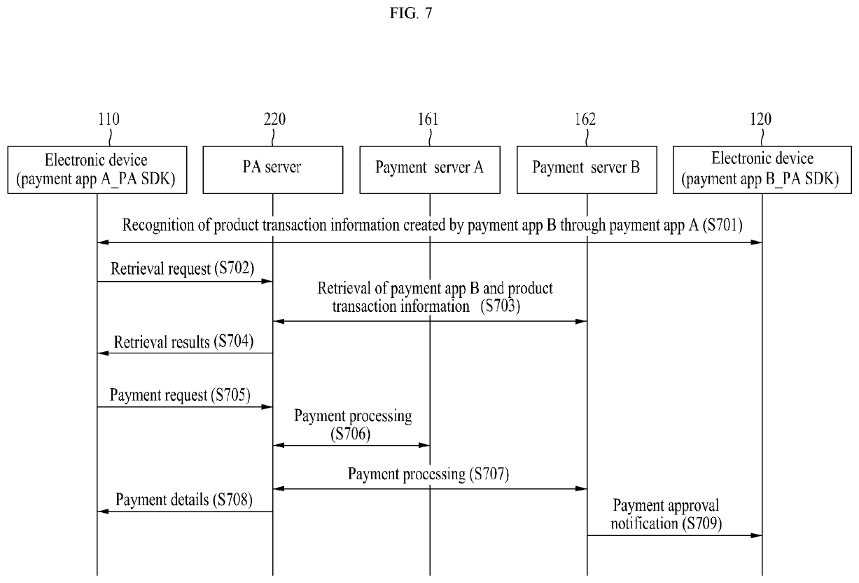

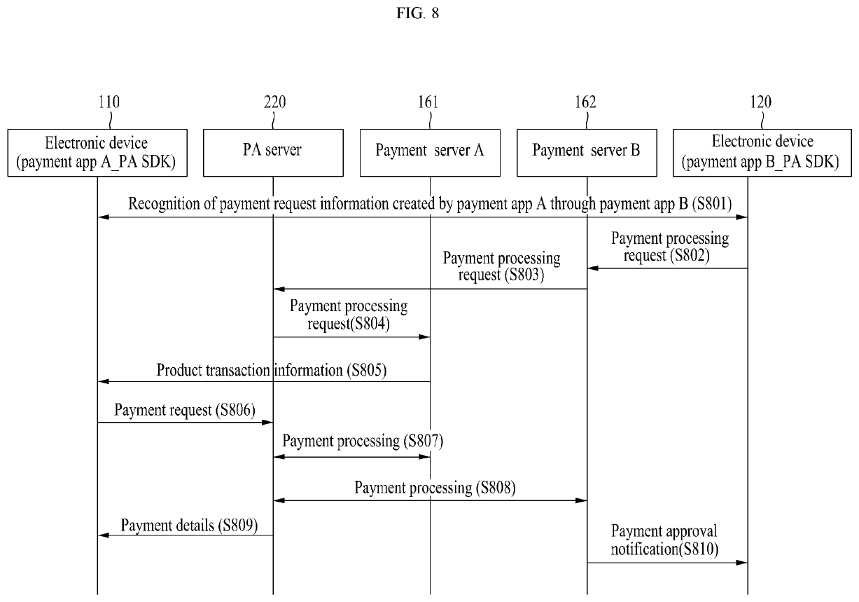

FIGS. 7 and 8 illustrate examples of a payment sequence diagram according to at least one example embodiment.

Referring to FIG. 7, in operation S701, the electronic device 110 on which an A payment application is installed may recognize product transaction information created by a payment application B installed on the electronic device 120 that is an affiliated store terminal through the payment application A.

The product transaction information may include an identifier and product information of an affiliated store for which transaction the user of the electronic device 110 requests. The product transaction information refers to data in a form capable of recognizing the corresponding affiliated store and a product and may be created through, for example, a quick response (QR) code, a barcode, and near field communication (NFC) in the payment application B. For example, a QR code according to the product transaction information created by the payment application B may be recognized through the payment application A installed on a user terminal of a user desiring to make a transaction with the affiliated store that uses the payment application B.

In operation S702, the payment application A installed on the electronic device 110 may request the PA server 220 to retrieve product transaction information by communicating with the PA server 220 through SDK or API call. Here, the retrieval request may include an identifier of the payment application B and product transaction information with respect to a product the user desires to transact with the affiliated store.

In operation S703, the PA server 220 may verify whether the payment application B corresponds to a payment link target in response to the retrieval request from the payment application A and may verify validity of the product transaction information included in the retrieval request through interaction with a payment server B 162 associated with the payment application B. Here, the payment server B 162 may retrieve the corresponding affiliated store and product information based on information on a platform with respect to the product transaction information requested by the PA server 220 and may return the retrieval results.

In operation S704, the PA server 220 may transmit the retrieval results corresponding to the retrieval request from the payment application A to the electronic device 110. The retrieval results may include results about at least one of whether the payment application B corresponds to the payment link target and whether the affiliated store and product information recognized through the payment application A are valid.

When the user of the electronic device 110 is capable of making a payment at the affiliated store that uses the payment application B with the payment application A, the electronic device 110 may include an identifier of the payment application A and product transaction information with respect to the product that the user desires to transact with the affiliated store. Here, the user may verify the affiliated store and product information the user desires to pay for and then may request a payment. In operation 5705, the payment application A on the electronic device 110 may request the PA server 220 for a payment for the product transaction information in response to the request from the user of the electronic device 110.

The PA server 220 may process a payment between heterogeneous payments by performing a payment application A side payment process for the product transaction information through interaction with an payment server A 161 in operation 5706 and by performing a payment application B side payment process for the product transaction information through interaction with the payment server B 162 in operation 5707.

Once the payment between the payment application A and the payment application B is completed, the PA server 220 may forward payment details about the product transaction information to the payment application A on the electronic device 110 in operation S708. Here, in operation 5709, the payment server B 162 may forward a payment approval notification according to payment processing to the payment application B on the electronic device 120.

Depending on example embodiments, a payment may be made in such a manner that the payment application A creates a QR code and the created QR code is recognized with the payment application B used at the affiliated store.

Referring to FIG. 8, in operation 5801, the electronic device 120 that is an affiliated store terminal may recognize payment request information created by the payment application A installed on the electronic device 110 through the payment application B. The payment application A on the electronic device 110 may create and display the payment request information in a form of a QR code in response to a request from the user of the electronic device 110. The payment request information may include an identifier of the payment application A and a user identifier. An affiliated store that desires to transact with the user that uses the payment application A may recognize the QR code, for example, the payment request information, created by the payment application A through the payment application B.

In operation S802, the payment application B on the electronic device 120 may request the payment server B 162 for processing a payment for the payment request information. The payment processing request may include the payment request information recognized by the payment application B and product transaction information. Here, the product transaction information may include an identifier of the affiliated store and product information the user of the electronic device 110 desires to purchase.

In operation S803, in response to the payment processing request received from the electronic device 120, the payment server B 162 may recognize that the corresponding payment was not made through the payment application B but through the payment application A, and may forward, to the PA server 220, the payment processing request that includes the payment request information and the product transaction information.

In operation S804, the PA server 220 may identify the payment application A based on the payment request information received from the payment server B 162 and may forward, to the payment server A 161, the payment processing request that includes the payment request information and the product transaction information.

In operation S805, the payment server A 161 may identify the user of the electronic device 110 based on the payment request information received from the PA server 220 and may forward the product transaction information to the electronic device 110. Here, the user of the electronic device 110 may verify the affiliated store and product information for which the user desires to pay through the payment application A and may request a payment.

In operation 5806, the payment application A on the electronic device 110 may request the PA server 220 for a payment for the product transaction information in response to the request from the user of the electronic device 110.

The PA server 220 may process a payment between heterogeneous pays by performing a payment application A side payment process for the product transaction information through interaction with the payment server A 161 in operation S807 and by performing a payment application B side payment process for the product transaction information through interaction with the payment server B 162 in operation S808.

Once the payment process between the payment application A and the payment application B is completed, the PA server 220 may forward payment details about the product transaction information to the payment application A on the electronic device 110 in operation S809. Here, in operation S810, the payment server B 162 may forward a payment approval notification according to payment processing to the payment application B on the electronic device 120.

Depending on example embodiments, a final payment may be processed after performing a payment reservation (or a payment hold) about the product transaction information between the payment application A and the payment application B. For example, a method of temporarily depositing a payment request amount may be applied to the payment reservation. The PA server 220 may temporarily deposit the payment request amount from the user account of the payment application A, may apply a payment fee and the like, and then may transfer a settlement amount to an account of the payment application B used by the affiliated store.

According to another example embodiment, the PA server 220 may link a payment between heterogeneous payments according to overseas or international purchase through interaction with the exchange rate system 40. When different currencies are used between the payment application A and the payment application B, the PA server 220 may link the payment between the heterogenous payments based on exchange rate information between the currency used in the payment application A and the currency used in the payment application B.

When a plurality of payment applications including the payment application B are available in the electronic device 120 that is an affiliated store terminal, payment application A to be used for a payment requested by the user of the electronic device 110 using the payment application A may be selected by the user of the electronic device 120 or may be automatically selected based on priority determined by the PA server 220 or by the electronic device 120. Priority of payment application A may be determined based on a transaction fee or various events of the payment application, such as, for example, benefits and promotions.

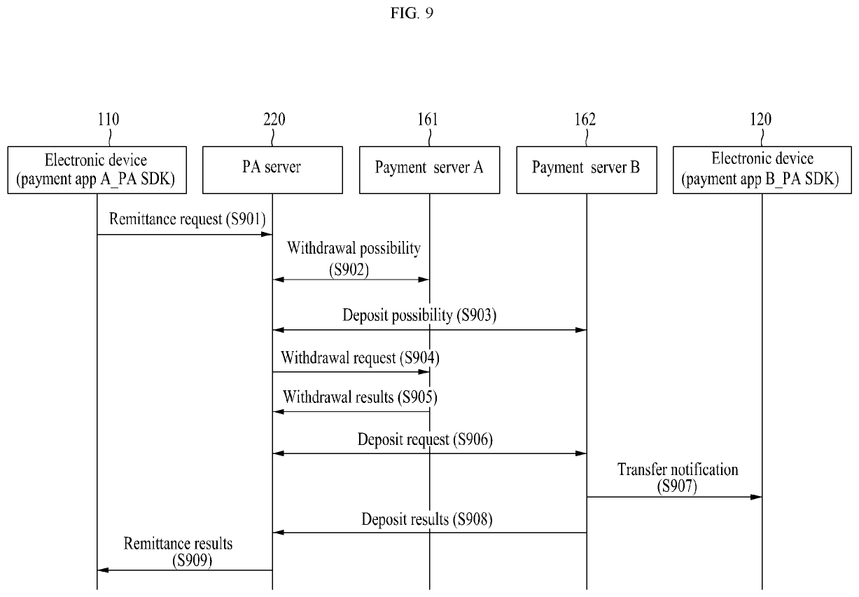

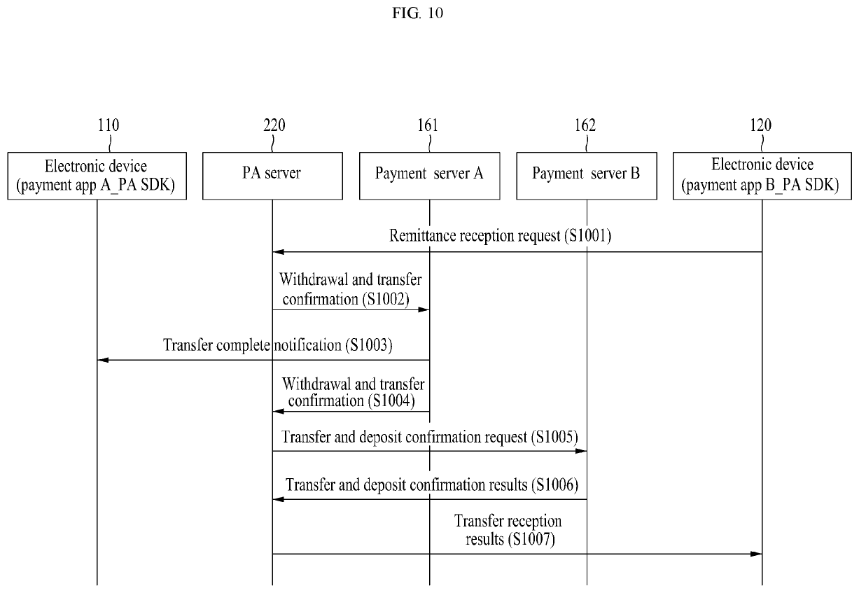

FIGS. 9 and 10 illustrate examples of a remittance sequence diagram according to at least one example embodiment.

The PA server 220 may support a remittance between heterogenous pays and, if different currencies are used therebetween, may also support a currency exchange based on an exchange rate.

Referring to FIG. 9, in operation S901, the electronic device 110 may request the PA server 220 for a remittance to the electronic device 120 using the payment application B as a remittance recipient specified by the user of the electronic device 110 through the payment application A.

The payment application A installed on the electronic device 110 may request the PA server 220 for the remittance by communicating with the PA server 220 through SDK or API call. Here, the remittance request may include remittance information that includes an identifier of the payment application B with which the payment application A desires to transact, an identifier of the electronic device 120, and an amount to be remitted.

In operation S902, in response to the remittance request from the payment application A, the PA server 220 may verify whether withdrawal from a user account of the payment application A is possible through interaction with the payment server A 161. The PA server 220 may verify a status or balance of the user account for the remittance request of the payment application A.

In operation S903, in response to the remittance request from the payment application A, the PA server 220 may verify whether a deposit to a user account of the payment application B is possible through interaction with the payment server B 162. The PA server 220 may verify a status of the user account of the payment application B for the remittance request from the payment application A.

When the withdrawal from the user account of the payment application A and the deposit to the user account of the payment application B are possible at the same time, the PA server 220 may determine that the remittance is possible.

When the remittance is determined to be possible, the PA server 220 may request the payment server A 161 for withdrawal of an amount corresponding to the remittance request from the payment application A in operation S904 and may receive withdrawal results from the payment server A 161 in operation S905.

When the remittance is determined to be possible, the PA server 220 may request the payment server B 162 for deposit of the amount corresponding to the remittance request from the payment application A in operation S906, and may receive deposit results from the payment server B 162 in operation S908. Here, in operation S907, the payment server B 162 may forward a transfer notification according to the deposit to the payment application B installed on the electronic device 120.

When remittance processing between the payment server A 161 and the payment server B 162 is completed, the PA server 220 may forward remittance results to the payment application A on the electronic device 110 in operation S909.

Referring to FIG. 10, in response to a request from the user of the electronic device 120 for receiving a remittance through the transfer notification received in operation S907, the payment application B installed on the electronic device 120 may request the PA server 220 for the remittance reception by communicating with the PA server 220 through SDK or API call in operation S1001. The remittance reception request may include remittance information that includes an identifier of the electronic device 110 and an amount to be remitted as well as an identifier of the payment application A corresponding to a remittance source.

In operation S1002, in response to the remittance reception request from the payment application B, the PA server 220 may request the payment server A 161 for withdrawal confirmation according to a transfer of the amount requested to be withdrawn in operation S904 through interaction with the payment server A 161.

In operation S1003, the payment server A 161 may forward a transfer complete notification about the amount requested to be remitted by the payment application A to the payment application A on the electronic device 110 at a point time at which the PA server 220 requests the payment server A 161 for the withdrawal confirmation. In operation S1004, the payment server A 161 may confirm withdrawal and transfer for the amount requested to be withdrawn in operation S904 in response to the remittance request from the payment application A and may forward confirmation results to the PA server 220.

When the withdrawal and transfer is confirmed from the payment server A 161, the PA server 220 may request the payment server B 162 for deposit confirmation according to transfer of the amount requested to be deposited in operation S906 through interaction with the payment server B 162 in operation S1005.

In operation S1006, the payment server B 162 may confirm the transfer and deposit of the amount requested to be deposited in operation S906 in response to the remittance request from the payment application A, and may forward confirmation results to the PA server 220.

When the transfer and deposit is confirmed from the payment server B 162, the PA server 220 may forward remittance reception results according to the remittance reception request from the payment application B to the payment application B on the electronic device 120 in operation S1007.

It is possible to support security for a user in performing a remittance between heterogenous pays, which may be implemented, for example, in such a manner that a payment application corresponding to a remittance destination provides its unique value using a QR code and a payment application corresponding to a remittance source specifies the remittance destination and remits an amount using the QR code.

Depending on example embodiments, the PA server 220 may link a transaction between heterogenous pays for an overseas remittance through interaction with the exchange rate system 40. For example, in the case of transferring Korean won (KRW) using a payment application in Korea to a payment application in China, an amount converted to yuan through application of an exchange rate may be transferred to the payment application in China.

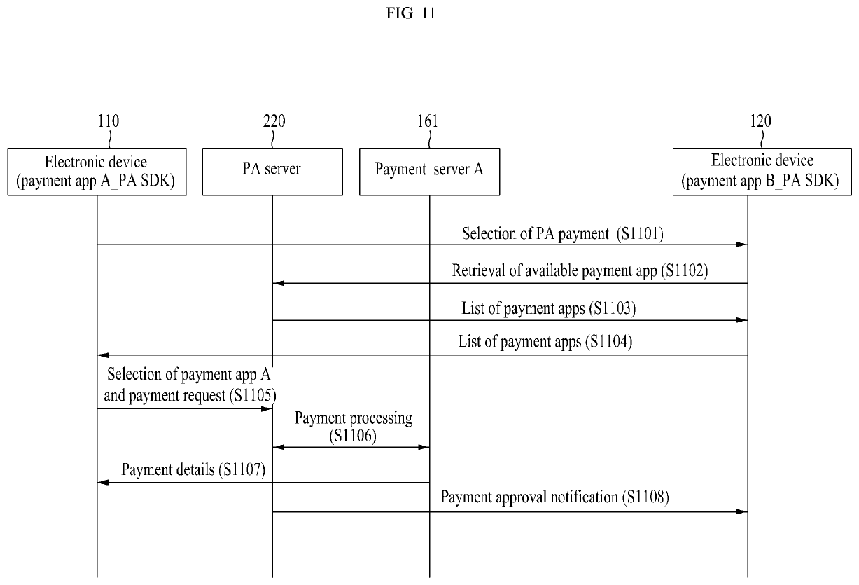

FIG. 11 illustrates an example of a plug-in sequence diagram according to at least one example embodiment.

The PA server 220 may support a transaction between heterogeneous pays and a payment using various payment applications through plug-ins inserted in web or apps.

Referring to FIG. 11, in a payment process in which the user of the electronic device 110 on which an payment application A is installed makes a payment in a shopping mall in which a plug-in for interaction with the PA server 220 is inserted, the electronic device 110 may forward a user selection on a payment method using the PA server 220 to a corresponding shopping mall server, for example, the server 160 of FIGS. 1 and 2, (hereinafter, referred to as the shopping mall server 160) in response to a selection from the user of the electronic device 110 on a button of the corresponding plug-in in operation S1101.

In operation S1102, in response to a PA payment selection of the user, the shopping mall server 160 may request the PA server 220 to retrieve a transactable payment application by communicating with the PA server 220 through SDK or API call.

In operation S1103, in response to the request from the shopping mall server 160, the PA server 220 may retrieve the transactable payment application and may forward a list of payment applications to the shopping mall server 160.

In operation S1104, the shopping mall server 160 may forward the list of payment applications received from the PA server 220 to the electronic device 110.

In addition to the list of payment applications transactable in the PA server 220, a list of payment applications used in the shopping mall server 160 in the list of payment applications transactable in the PA server 220 may also be provided.

In operation S1105, the electronic device 110 may select an available payment application, for example, the payment application A, from the list of payment applications transactable in the PA server 220 and may request the PA server 220 for a payment using the payment application A. Here, the payment application A on the electronic device 110 may forward the payment request to the PA server 220 by communicating with the PA server 220 through SDK or API call.

In operation S1106, the PA server 220 may process a payment requested by the payment application A on the electronic device 110 through interaction with the payment server A 161 associated with the payment application A.

Once the payment requested by the payment application A on the electronic device 110 is completed, the payment server A 161 may forward payment details according to payment processing to the payment application A on the electronic device 110 in operation S1107 and the PA server 220 may forward a payment approval notification about the electronic device 110 to the shopping mall server 160 in operation S1108.

The electronic device 110 may distinguishably display a payment application available in the electronic device 110 in a list of payment applications for easy user verification. Here, the electronic device 110 may select an available payment application from the list of payment applications and may request a payment using the selected payment application. For example, if a plurality of payment applications is available in the electronic device 110, a payment application may be selected by the user of the electronic device 110 or may be automatically selected in a random manner. As another example, if a plurality of payment applications including the payment application A is available in the electronic device 110, the electronic device 110 may display corresponding payment applications that are sorted based on priority determined by the PA server 220 or the shopping mall server 160 or may automatically select a payment application to be used for a payment. For example, priority of a payment application may be determined based on a transaction fee or various events of the payment application, such as, for example, benefits and promotions. That is, the user of the electronic device 110 may select a payment application to be used for a payment from among payment applications available in the electronic device 110. Alternatively, the payment application may be selected based on a priority condition of the PA server 220 or the shopping mall server 160.

A final payment may be processed after performing a payment or a payment reservation using a plug-in. For example, a method of temporarily depositing a payment request amount may be applied to the payment reservation. The PA server 220 may temporarily deposit the payment request amount from the user account of the payment application A, may apply a payment fee and the like, and then may transfer a settlement amount to an account of the shopping mall server 160.

The PA server 220 may support a payment according to overseas purchase through the exchange rate system 40, and may apply to all the transaction activities, such as a reservation and a product purchase.

According to some example embodiments, it is possible to link a transaction between heterogeneous payment applications each providing a simple payment service.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A payment link method implemented by a computer system, the payment link method comprising:
verifying whether a second payment application is a transaction link target in response to a transaction request, which is received from a first payment application installed on an electronic device, occurring at a payment processing system that uses the second payment application different from the first payment application; and
forwarding payment information on the first payment application to a payment server associated with the second payment application and linking a transaction between the first payment application and the second payment application in response to the second payment application corresponding to the transaction link target.

2. The payment link method of claim 1, wherein the linking the transaction comprises processing the payment information on the first payment application to information transactable on the second payment application and forwarding the processed payment information to the payment server.

3. The payment link method of claim 1, wherein the linking the transaction comprises:
verifying that an amount corresponding to the transaction request from a user account of the first payment application is deposited; and
settling the deposited amount to be transferred to the payment server based on a preset condition.

4. The payment link method of claim 1, wherein the linking the transaction comprises creating a virtual user of the second payment application for an authorized user of the first payment application.

5. The payment link method of claim 1, wherein the verifying comprises retrieving the second payment application from a list of payment applications pre-registered as targets to support a heterogenous payment link between different payment applications.

6. The payment link method of claim 1, wherein the payment server associated with the second payment application is a second payment server, and
wherein the linking the transaction comprises processing a payment for product transaction information created by the second payment application through interaction with a first payment server associated with the first payment application and the second payment server in response to receiving a payment request from the first payment application for the product transaction information.

7. The payment link method of claim 1, wherein the payment server associated with the second payment application is a second payment server, and
wherein the linking the transaction comprises processing a remittance for an amount corresponding to a remittance request through interaction with a first payment server associated with the first payment application and the second payment server in response to receiving, from the first payment application, the remittance request for the payment processing system that uses the second payment application.

8. The payment link method of claim 1, further comprising:
selecting a payment application to be used for a first transaction with the first payment application based on priority set by the computer system or the payment processing system in response to a plurality of payment applications comprising the second payment application being used at the payment processing system.

9. The payment link method of claim 1, further comprising:
selecting a payment application to be used for a second transaction with the second payment application based on priority set by the computer system or the payment processing system, in response to a plurality of payment applications comprising the first payment application being used by the electronic device.

10. The payment link method of claim 1, wherein the linking the transaction comprises linking the transaction between the first payment application and the second payment application based on exchange rate information between a first currency used in the first payment application and a second currency used in the second payment application in response to the first currency being different from the second currency.

11. A non-transitory computer-readable record medium storing instructions that, when executed by a processor, cause the processor to perform the payment link method of claim 1.

12. A computer system comprising:
at least one memory configured to store computer-readable instructions; and
at least one processor configured to execute the computer-readable instructions to:
verify whether a second payment application is a transaction link target in response to a transaction request, which is received from a first payment application installed on an electronic device, occurring at a payment processing system that uses the second payment application different from the first payment application; and
forward payment information on the first payment application to a payment server associated with the second payment application and link a transaction between the first payment application and the second payment application in response to the second payment application corresponding to the transaction link target.

13. The computer system of claim 12, wherein the at least one processor is further configured to execute the computer-readable instructions to:
process the payment information on the first payment application to information transactable on the second payment application; and
forward the processed payment information to the payment server to link the transaction between the first payment application and the second payment application.

14. The computer system of claim 12, wherein the at least one processor is further configured to execute the computer-readable instructions to:
verify that an amount corresponding to the transaction request from a user account of the first payment application is deposited; and
settle the deposited amount to be transferred to the payment server based on a preset condition.

15. The computer system of claim 12, wherein the at least one processor is further configured to execute the computer-readable instructions to:
create a virtual user of the second payment application for an authorized user of the first payment application.

16. The computer system of claim 12, wherein the at least one processor is further configured to execute the computer-readable instructions to:
retrieve the second payment application from a list of payment applications pre-registered as targets to support a heterogenous payment link between different payment applications.

17. The computer system of claim 12, wherein the payment server associated with the second payment application is a second payment server, and
wherein the at least one processor is further configured to execute the computer-readable instructions to:
process a payment for product transaction information created by the second payment application through interaction with a first payment server associated with the first payment application and the second payment server in response to receiving a payment request from the first payment application for the product transaction information.

18. The computer system of claim 12, wherein the payment server associated with the second payment application is a second payment server, and
wherein the at least one processor is further configured to execute the computer-readable instructions to:
process a remittance for an amount corresponding to a remittance request through interaction with a first payment server associated with the first payment application and the second payment server in response to receiving, from the first payment application, the remittance request for the payment processing system that uses the second payment application.

19. The computer system of claim 12, wherein the at least one processor is further configured to execute the computer-readable instructions to:
select a payment application to be used for a first transaction with the first payment application based on priority set by the computer system or the payment processing system, in response to a plurality of payment applications comprising the second payment application being used at the payment processing system.

20. The computer system of claim 12, wherein the at least one processor is further configured to execute the computer-readable instructions to:
link the transaction between the first payment application and the second payment application based on exchange rate information between a first currency used in the first payment application and a second currency used in the second payment application in response to the first currency being different from the second currency.
